(19) United States
(12) Patent Application Publication
(10) Pub. No.: US 2021/0352212 A1
(43) Pub. Date: Nov. 11, 2021

(54) VIDEO IMAGE PROCESSING METHOD AND APPARATUS

(71) Applicant: SHENZHEN SENSETIME TECHNOLOGY CO., LTD., Shenzhen (CN)

(72) Inventors: Shangchen Zhou, Shenzhen (CN); Jiawei Zhang, Shenzhen (CN); Sijie Ren, Shenzhen (CN)

(21) Appl. No.: 17/384,910

(22) Filed: Jul. 26, 2021

Related U.S. Application Data
(63) Continuation of application No. PCT/CN2019/114139, filed on Oct. 29, 2019.

(30) Foreign Application Priority Data
Apr. 22, 2019 (CN) 201910325282.5

(51) Int. Cl. H04N 5/232; G06N 3/02

(52) U.S. Cl. CPC H04N 5/23267; G06N 3/02

(57) ABSTRACT

Disclosed in embodiments of the present application are a video image processing method and apparatus. The method comprises: acquiring multiple frames of consecutive video images which comprise an Nth image frame, an (N−1)th frame of image and an (N−1)th frame of deblurred image, N being a positive integer; obtaining a deblurring convolutional kernel of the Nth image frame on the basis of the Nth image frame, the (N−1)th image frame, and the deblurred (N−1)th image frame; and performing deblurring processing on the Nth image frame by using the deblurring convolution kernel to obtain a deblurred Nth image frame.

### CROSS-REFERENCE TO RELATED APPLICATION

This is a continuation application of International Patent Application No. PCT/CN2019/114139, filed on Oct. 29, 2019, which claims priority to Chinese Patent Application No. 201910325282.5, filed on Apr. 22, 2019. The disclosures of International Patent Application No. PCT/CN2019/114139 and Chinese Patent Application No. 201910325282.5 are hereby incorporated by reference in their entireties.

### BACKGROUND

Along with the increasing popularization of application of hand-held cameras and onboard cameras, more and more users shoot videos through cameras and may perform processing based on the shot videos. For example, an unmanned aerial vehicle and an autonomous vehicle may realize functions of tracking, obstacle avoidance and the like based on shot videos.

It is likely that a shot video is blurry for reasons such as camera jitter, defocusing and high-speed movement of a shooting object, for example, blurry due to camera jitter or movement of the shooting object during movement of a robot, usually resulting in a shooting failure or making it is impossible to perform subsequent processing based on the video. Through a conventional method, a video image may be deblurred through an optical flow or a neural network, but a deblurring effect is relatively poor.

### SUMMARY

The application relates to the technical field of image processing, and particularly to a video image processing method and device.

Embodiments of the application provide a video image processing method and device.

According to a first aspect, the embodiments of the application provide a video image processing method, which may include that: multiple frames of continuous video images are acquired, the multiple frames of continuous video images including an Nth frame of image, an (N−1)th frame of image and an (N−1)th frame of deblurred image and N being a positive integer; deblurring convolution kernels for the Nth frame of image is obtained based on the Nth frame of image, the (N−1)th frame of image and the (N−1)th frame of deblurred image; and deblurring processing is performed on the Nth frame of image through the deblurring convolution kernels to obtain an Nth frame of deblurred image.

According to a second aspect, the embodiments of the application provide a video image processing device, which may include: an acquisition unit, configured to acquire multiple frames of continuous video images, the multiple frames of continuous video images including an Nth frame of image, an (N−1)th frame of image and an (N−1)th frame of deblurred image and N being a positive integer; a first processing unit, configured to obtain deblurring convolution kernels for the Nth frame of image based on the Nth frame of image, the (N−1)th frame of image and the (N−1)th frame of deblurred image; and a second processing unit, configured to perform deblurring processing on the Nth frame of image through the deblurring convolution kernels to obtain an Nth frame of deblurred image.

According to a third aspect, the embodiments of the application also provide a processor, which is configured to execute the method of the first aspect and any possible implementation mode thereof.

According to a fourth aspect, the embodiments of the application also provide an electronic device, which may include a processor, an input device, an output device and a memory. The processor, the input device, the output device and the memory may be connected with one another. The memory may store program instructions. The program instructions may be executed by the processor to enable the processor to execute the method of the first aspect and any possible implementation mode thereof.

According to a fifth aspect, the embodiments of the application also provide a computer-readable storage medium, in which a computer program may be stored, the computer program including program instructions and the program instructions being executed by a processor of an electronic device to enable the processor to execute the method of the first aspect and any possible implementation mode thereof.

It is to be understood that the above general description and the following detailed description are only exemplary and explanatory and not intended to limit the embodiments of the disclosure.

### BRIEF DESCRIPTION OF THE DRAWINGS

In order to describe the technical solutions in the embodiments of the application or a background art more clearly, the drawings required to be used for descriptions about the embodiments of the application or the background art will be described below.

The accompanying drawings, which are incorporated in and constitute a part of this specification, illustrate embodiments consistent with the disclosure and, together with the specification, serve to describe the technical solutions of the disclosure.

FIG. 1 is a schematic diagram of corresponding pixels in different images according to embodiments of the application.

FIG. 2 is a non-uniformly blurred image according to embodiments of the application.

FIG. 3 is a flowchart of a video image processing method according to embodiments of the application.

FIG. 4 is a flowchart of deblurring processing in a video image processing method according to embodiments of the application.

FIG. 5 is a flowchart of another video image processing method according to embodiments of the application.

FIG. 6 is a flowchart of obtaining deblurring convolution kernels and alignment convolution kernels according to embodiments of the application.

FIG. 7 is a schematic diagram of an encoding module according to embodiments of the application.

FIG. 8 is a schematic diagram of an alignment convolution kernel generation module according to embodiments of the application.

FIG. 9 is a schematic diagram of a deblurring convolution kernel generation module according to embodiments of the application.

FIG. 10 is a flowchart of another video image processing method according to embodiments of the application.

FIG. 11 is a schematic diagram of an adaptive convolution processing module according to embodiments of the application.

FIG. 12 is a schematic diagram of a decoding module according to embodiments of the application.

FIG. 13 is a structure diagram of a video image deblurring neural network according to embodiments of the application.

FIG. 14 is a structure diagram of a generation module for alignment convolution kernel and deblurring convolution kernel according to embodiments of the application.

FIG. 15 is a structure diagram of a video image processing device according to embodiments of the application.

FIG. 16 is a hardware structure diagram of an electronic device according to embodiments of the application.

### DETAILED DESCRIPTION

In order to make the solutions of the application understood by those skilled in the art, the technical solutions in the embodiments of the application will be clearly and completely described below in combination with the drawings in the embodiments of the application. It is apparent that the described embodiments are not all embodiments but only part of embodiments of the application. All other embodiments obtained by those of ordinary skill in the art based on the embodiments in the application without creative work shall fall within the scope of protection of the application.

Terms “first”, “second” and the like in the specification, claims and drawings of the application are adopted not to describe a specific sequence but to distinguish different objects. In addition, terms “include” and “have” and any transformations thereof are intended to cover nonexclusive inclusions. For example, a process, method, system, product or device including a series of steps or units is not limited to the steps or units which have been listed but optionally further includes steps or units which are not listed or optionally further includes other steps or units intrinsic to the process, the method, the product or the device.

“Embodiment” mentioned in the disclosure means that a specific feature, structure or characteristic described in combination with an embodiment may be included in at least one embodiment of the application. Each position where this phrase appears in the specification does not always refer to the same embodiment as well as an independent or alternative embodiment mutually exclusive to another embodiment. It is explicitly and implicitly understood by those skilled in the art that the embodiments described in the disclosure may be combined with other embodiments.

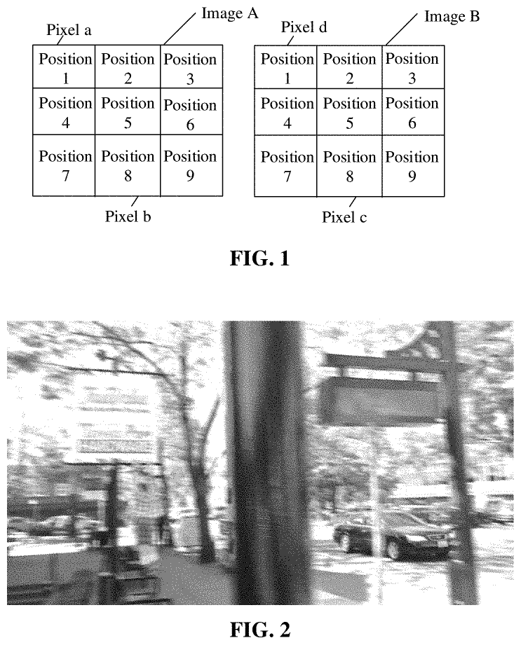

In some embodiments, term “correspond” appears frequently. Corresponding pixels in two images refer to two pixels at the same position in the two images. For example, as shown in FIG. 1, a pixel a in an image A corresponds to a pixel d in an image B, and a pixel b in the image A corresponds to a pixel c in the image B. It is to be understood that corresponding pixels in multiple images have the same meaning as corresponding pixels in two images.

A non-uniformly blurred image appearing below refers to that different pixels in an image are different in blurriness, namely motion trajectories of different pixels are different. For example, as shown in FIG. 2, the blurriness of characters on a sign in a left upper region is higher than the blurriness of an automobile in the right lower corner, namely the two regions are different in blurriness. With application of the embodiments of the application, a blur in the non-uniformly blurred image may be removed. The embodiments of the application will be described in combination with the drawings in the embodiments of the application.

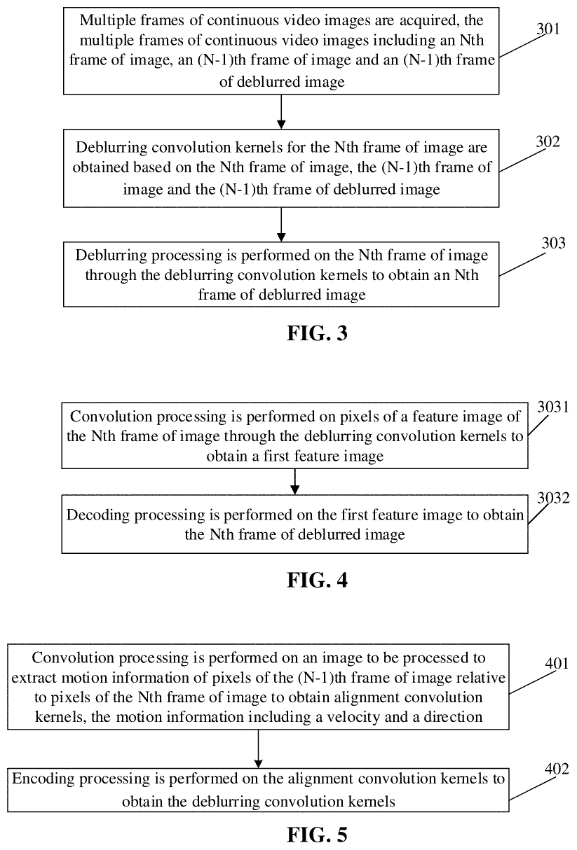

Referring to FIG. 3, FIG. 3 is a flowchart of a video image processing method according to embodiments of the application. As shown in FIG. 3, the method includes the following operations.

In 301, multiple frames of continuous video images are acquired, the multiple frames of continuous video images including an Nth frame of image, an (N−1)th frame of image and an (N−1)th frame of deblurred image and N being a positive integer.

In some embodiments, multiple frames of continuous video images may be obtained by shooting a video through a camera. The Nth frame of image and the (N−1)th frame of image are two adjacent frames of images in the multiple frames of continuous video images, the Nth frame of image is a next frame of image of the (N−1)th frame of image, and the Nth frame of image is a frame of image presently to be processed (namely blurring processing is performed by use of the implementation mode provided in the application). The (N−1)th frame of blurred image is an image obtained after blurring processing is performed on the (N−1)th frame of image.

It is to be understood that the embodiments of the application is a recursive deblurring process for the video images, namely the (N−1)th frame of deblurred image is taken as an input image of a deblurring processing process for the Nth frame of image, and similarly, an Nth frame of deblurred image is taken as an input image of a deblurring processing process for an (N+1)th frame of image.

In some embodiments, if N is 1, namely a present deblurring processing object is a first frame in the video, both the (N−1)th frame of image and the (N−1)th frame of deblurred image are the Nth frame, namely three first frames of images are acquired.

In some embodiments, a sequence obtained by arranging each frame of image in the video according to a shooting time sequence is called a video frame sequence. An image obtained by deblurring processing is called a deblurred image.

In some embodiments, deblurring processing is performed on the video images according to the video frame sequence, and deblurring processing is performed on only one frame of image every time.

In some embodiments, the video images and deblurred images may be stored in a memory of an electronic device. The video refers to a video stream, namely the video images are sequentially stored in the memory of the electronic device according to the video frame sequence. Therefore, the electronic device may directly acquire the Nth frame of image, the (N−1)th frame of image and the (N−1)th frame of deblurred image from the memory.

It is to be understood that the video images mentioned in some embodiments may be a video shot in real time through the camera of the electronic device and may also be video images stored in the memory of the electronic device.

In 302, deblurring convolution kernels for the Nth frame of image is obtained based on the Nth frame of image, the (N−1)th frame of image and the (N−1)th frame of deblurred image.

In some embodiments, the operation that the deblurring convolution kernels for the Nth frame of image are obtained based on the Nth frame of image, the (N−1)th frame of image and the (N−1)th frame of deblurred image includes that: convolution processing is performed on pixels of an image to be processed to obtain the deblurring convolution kernels, the image to be processed being obtained by concatenating the Nth frame of image, the (N−1)th frame of image and the (N−1)th frame of deblurred image in a channel dimension.

In the embodiment, the Nth frame of image, the (N−1)th frame of image and the (N−1)th frame of deblurred image are concatenated in the channel dimension to obtain the image to be processed. For example (an example 1), there is made such a hypothesis that a size of each of the Nth frame of image, the (N−1)th frame of image and the (N−1)th frame of deblurred image is 100*100*3 and a size of the image to be processed obtained by concatenation is 100*100*9. That is, the number of pixels of the image to be processed obtained by concatenating the three images (the Nth frame of image, the (N−1)th frame of image and the (N−1)th frame of deblurred image) is the same as the number of pixels in any image in the three images, but a number of channels of each pixel becomes triple that of any image in the three images.

In the embodiment of the application, convolution processing over the pixels of the image to be processed may be implemented by multiple randomly concatenated convolutional layers. The numbers of the convolutional layers and sizes of convolution kernels in the convolutional layers are not limited in the embodiments of the application.

Convolution processing may be performed on the pixels of the image to be processed to extract feature information of the pixels in the image to be processed to obtain the deblurring convolution kernels. The feature information includes motion information of pixels of the (N−1)th frame of image relative to pixels of the Nth frame of image and deblurring information of the pixels of the (N−1)th frame of image relative to pixels of the (N−1)th frame of deblurred image. The motion information includes a motion velocities and motion directions of the pixels in the (N−1)th frame of image relative to the corresponding pixels in the Nth frame of image.

It is to be understood that the deblurring convolution kernels in the embodiments of the application are a result obtained by performing convolution processing on the image to be processed and are used as convolution kernels for convolution processing during subsequent processing in the embodiments of the application.

It is also to be understood that performing convolution processing on the pixels of the image to be processed refers to performing convolution processing on each pixel of the image to be processed to obtain a deblurring convolution kernel for each pixel. Following the example 1 (as an example 2), if the size of the image to be processed is 100*100*9, namely the image to be processed includes 100*100 pixels, convolution processing may be performed on the pixels of the image to be processed to obtain a 100*100 feature image, and each pixel in the 100*100 feature image may be used as a deblurring convolution kernel for subsequently performing deblurring processing on the pixels in the Nth frame of image.

In 303, deblurring processing is performed on the Nth frame of image through the deblurring convolution kernels to obtain an Nth frame of deblurred image.

In some embodiments, as shown in FIG. 4, the operation that deblurring processing is performed on the Nth frame of image through the deblurring convolution kernels to obtain the Nth frame of deblurred image may include the following operations.

In 3031, convolution processing is performed on pixels of a feature image of the Nth frame of image through the deblurring convolution kernels to obtain a first feature image.

The feature image of the Nth frame of image may be obtained by performing feature extraction processing on the Nth frame of image. Feature extraction processing may be convolution processing and may also be pooling processing, and no limits are made thereto in the embodiments of the application.

The deblurring convolution kernel for each pixel in the image to be processed is obtained by processing in 302. The number of the pixels of the image to be processed is the same as the number of the pixels of the Nth frame of image, and the pixels in the image to be processed correspond to the pixels in the Nth frame of image one to one. In the embodiments of the application, the meaning of one-to-one correspondence may refer to the following example: a pixel A in the image to be processed corresponds to a pixel B in the Nth frame of image one to one, namely a position of the pixel A in the image to be processed is the same as a position of the pixel B in the Nth frame of image.

In 3032, decoding processing is performed on the first feature image to obtain the Nth frame of deblurred image.

Decoding processing may be implemented by deconvolution processing and may also be implemented by combining deconvolution processing and convolution processing, and no limits are made thereto in the embodiments of the application.

In some embodiments, for improving a deblurring processing effect on the Nth frame of image, pixel values of pixels in an image obtained by performing decoding processing on the first feature image and pixel values of the pixels of the Nth frame of image are added, and an image obtained by “addition” is taken as the Nth frame of deblurred image. The Nth frame of deblurred image may be obtained by “addition” by use of information of the Nth frame of image.

For example, if a pixel value of a pixel C in the image obtained by decoding processing is 200 and a pixel value of a pixel D in the Nth frame of image is 150, a pixel value of a pixel E in the Nth frame of deblurred image obtained by “addition” is 350, a position of C in the image to be processed, a position of D in the Nth frame of image and a position of E in the Nth frame of deblurred image being the same.

As mentioned above, motion trajectories of different pixels in a non-uniformly blurred image are different, and if the motion trajectory of a pixel is more complex, blurriness thereof is higher. In the embodiment of the application, the deblurring convolution kernel is predicted for each pixel in the image to be processed, and convolution processing is performed on a feature point in the Nth frame of image through the predicted deblurring convolution processing to deblur the pixel in the Nth frame of image. Since different pixels in the non-uniformly blurred image are different in blurriness, it is apparent that generating corresponding deblurring convolution kernels for different pixels may deblur each pixel better and further implement deblurring of the non-uniformly blurred image.

In some embodiments, deblurring convolution kernels for pixels are obtained based on deblurring information between the pixels of the (N−1)th frame of image and the pixels of the (N−1)th frame of deblurred image, and then deconvolution processing is performed on the corresponding pixels in the Nth frame of image by use of the deblurring convolution kernels to deblur the pixels in the Nth frame of image. A deblurring convolution kernel is generated for each pixel in the Nth frame of image, so that the Nth frame of image (non-uniformly blurred image) may be deblurred, the deblurred image is clear and natural, and the whole deblurring processing process is low in time consumption and high in processing speed.

Referring to FIG. 5, FIG. 5 is a flowchart of a possible implementation manner of 302 according to embodiments of the application. As shown in FIG. 5, the method includes the following operations.

In 401, convolution processing is performed on an image to be processed to extract motion information of pixels of the (N−1)th frame of image relative to pixels of the Nth frame of image to obtain alignment convolution kernels, the motion information including a velocity and a direction.

In some embodiments, that the motion information includes the velocity and the direction can be understood as the motion information of a pixel, which refers to a motion trajectory of the pixel from a moment of the (N−1)th frame (a moment when the (N−1)th frame of image is shot) to a moment of the Nth frame (a moment when the Nth frame of image is shot).

Since a shot object is moving in single exposure time and a motion trajectory is curvilinear, a shot image may be blurry. That is, the motion information of the pixels of the (N−1)th frame of image relative to the pixels of the Nth frame of image is favorable for deblurring the Nth frame of image.

In some embodiments, convolution processing over the pixels of the image to be processed may be implemented by multiple randomly concatenated convolutional layers. The number of the convolutional layers and sizes of convolution kernels in the convolutional layers are not limited in the embodiments of the application.

Convolution processing may be performed on the pixels of the image to be processed to extract the feature information of the pixels in the image to be processed to obtain the deblurring convolution kernel. Herein, the feature information includes the motion information of the pixels of the (N−1)th frame of image relative to the pixels of the Nth frame of image.

It is to be understood that the alignment convolution kernels in some embodiments are a result obtained by performing convolution processing on the image to be processed and are used as convolution kernels for convolution processing during subsequent processing in some embodiments. Specifically, the alignment convolution kernels are obtained by performing convolution processing on the image to be processed to extract the motion information of the pixels of the (N−1)th frame of image relative to the pixels of the Nth frame of image, so that alignment processing may subsequently be performed on the pixels of the Nth frame of image through the alignment convolution kernels.

It is to be pointed out that the alignment convolution kernels obtained in the embodiment are also obtained in real time, namely an alignment convolution kernel for each pixel in the Nth frame of image is obtained by such processing.

In 402, encoding processing is performed on the alignment convolution kernels to obtain the deblurring convolution kernels.

Herein, encoding processing may be convolution processing and may also be pooling processing.

In a possible implementation mode, encoding processing is convolution processing and convolution processing may be implemented by multiple randomly concatenated convolutional layers. The number of the convolutional layers and sizes of convolution kernels in the convolutional layers are not limited in some embodiments.

It is to be understood that convolution processing in 402 is different from convolution processing in 401. For example, there is made such a hypothesis that convolution processing in 401 is implemented by three convolutional layers of which numbers of channels are 32 (sizes of convolution kernels are 3*3) and convolution processing in 402 is implemented by five convolutional layers of which numbers of channels are 64 (sizes of convolution kernels are 3*3), both (three convolutional layers and five convolutional layers) are essentially convolution processing, but specific implementation processes thereof are different.

Since the image to be processed is obtained by concatenating the Nth frame of image, the (N−1)th frame of image and the (N−1)th frame of deblurred image in the channel dimension, the image to be processed includes information of the Nth frame of image, the (N−1)th frame of image and the (N−1)th frame of deblurred image. Convolution processing in 401 focuses more on extraction of the motion information of the pixels of the (N−1)th frame of image relative to the pixels of the Nth frame of image. That is, by processing in 401, the deblurring processing information between the (N−1)th frame of image and (N−1)th frame of deblurred image in the image to be processed is not extracted.

In some embodiments, before encoding processing is performed on the alignment convolution kernels, concatenation processing may be performed on the image to be processed and the alignment convolution kernels such that the alignment convolution kernels obtained by concatenation include the deblurring information between the (N−1)th frame of image and the (N−1)th frame of deblurred image.

Convolution processing is performed on the alignment convolution kernels to extract the deblurring information of the (N−1)th frame of deblurred image relative to the pixels of the (N−1)th frame of image to obtain the deblurring convolution kernels. The deblurring information may be understood as mapping relationships between the pixels of the (N−1)th frame of image and the pixels of the (N−1)th frame of deblurred image, i.e., mapping relationships between pixels before deblurring processing and pixels after deblurring process.

In such a manner, the deblurring convolution kernels obtained by performing convolution processing on the alignment convolution kernels not only include the deblurring information between the pixels of the (N−1)th frame of image and the pixels of the (N−1)th frame of deblurred image but also include the motion information between the pixels of the (N−1)th frame of image and the pixels of the Nth frame of image. Subsequently performing convolution processing on the pixels of the Nth frame of image through the deblurring convolution kernels may improve the deblurring effect.

In some embodiments, the alignment convolution kernels for the pixels are obtained based on the motion information between the pixels of the (N−1)th frame of image and the pixels of the Nth frame of image, and alignment processing may subsequently be performed through the alignment convolution kernels. Then, convolution processing is performed on the alignment convolution kernels to extract the deblurring information between the pixels of the (N−1)th frame of image and the pixels of the (N−1)th frame of deblurred image to obtain the deblurring convolution kernels, so that the deblurring convolution kernels may not only include the deblurring information between the pixels of the (N−1)th frame of image and the pixels of the (N−1)th frame of deblurred image but also include the motion information between the pixels of the (N−1)th frame of image and the pixels of the Nth frame of image, which is favorable for improving the deblurring effect on the Nth frame of image.

In all the abovementioned embodiments, convolution processing is performed on the image to obtain the deblurring convolution kernels and the alignment convolution kernels. Since the image includes a large number of pixels, if the image is directly processed, a data size required to be processed is large and the processing speed is low. Therefore, the embodiments of the application provide an implementation manner of obtaining the deblurring convolution kernels and the alignment convolution kernels according to a feature image.

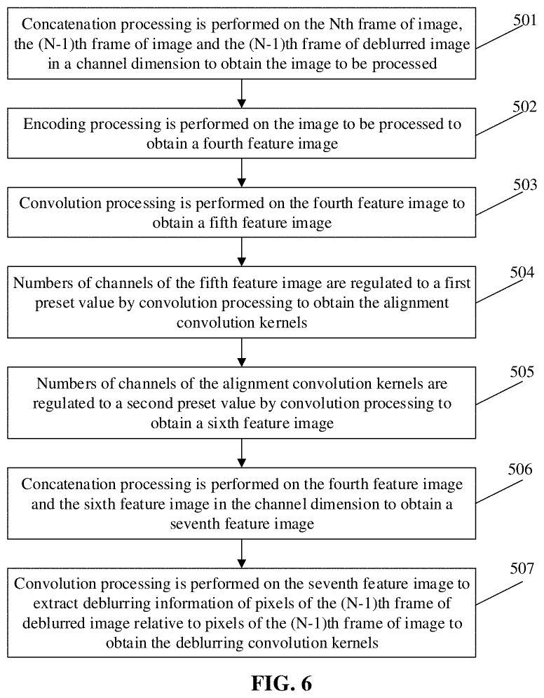

Referring to FIG. 6, FIG. 6 is a flowchart of obtaining deblurring convolution kernels and alignment convolution kernels according to embodiments of the application. As shown in FIG. 6, the method includes the following operations.

In 501, concatenation processing is performed on the Nth frame of image, the (N−1)th frame of image and the (N−1)th frame of deblurred image in a channel dimension to obtain the image to be processed.

This operation refers to the implementation manner of obtaining the image to be processed in 302 and will not be elaborated herein.

In 502, encoding processing is performed on the image to be processed to obtain a fourth feature image.

Encoding processing may be implemented in multiple manners such as convolution and pooling, and no specific limits are made thereto in some embodiments.

In some possible implementation modes, referring to FIG. 7, a module shown in FIG. 7 may be configured to perform encoding processing on the image to be processed. The module sequentially includes a convolutional layer of which a number of channels is 32 (a size of a convolution kernel is 3*3), two residual blocks of which numbers of channels are 32 (each residual block includes two convolutional layers, and sizes of convolution kernels of the convolutional layers are 3*3), a convolutional layer of which a number of channels is 64 (a size of a convolution kernel is 3*3), two residual blocks of which numbers of channels are 64 (each residual block includes two convolutional layers, and sizes of convolution kernels of the convolutional layers are 3*3), a convolutional layer of which a number of channels is 128 (a size of a convolution kernel is 3*3) and two residual blocks of which numbers of channels are 128 (each residual block includes two convolutional layers, and sizes of convolution kernels of the convolutional layers are 3*3).

Convolution processing is performed on the image to be processed layer by layer through the module to complete encoding of the image to be processed to obtain the fourth feature image. Feature contents and semantic information extracted by each convolutional layer are different. Specifically, by encoding processing, features of the image to be processed are abstracted step by step, and meanwhile, the features relatively minor in importance are gradually removed. Therefore, a size of a feature image which is extracted later is smaller, and semantic information is more compressed. Through the multiple convolutional layers, convolution processing is performed on the image to be processed step by step and the corresponding features are extracted to finally obtain the fourth feature image with a fixed size. Therefore, the size of the image may be reduced at the same time of obtaining main content information (i.e., the fourth feature image) of the image to be processed, the data processing load is reduced, and the processing speed is increased.

For example (an example 3), if the size of the image to be processed is 100*100*3, the size of the fourth feature image obtained by performing encoding processing on the module shown in FIG. 7 is 25*25*128.

In a possible implementation mode, an implementation process of convolution processing is as follows: convolution processing is performed on the image to be processed through the convolutional layers, namely the convolution kernels slide on the image to be processed, the pixels of the image to be processed are multiplied by corresponding numerical values of the convolution kernels, then all values obtained by multiplication are added to obtain a pixel value, corresponding to an intermediate pixel of the convolution kernel, in the image, and finally all the pixels in the image to be processed are processed by sliding to obtain the fourth feature image. In some embodiments, in the possible implementation mode, a step of the convolutional layer may be 2.

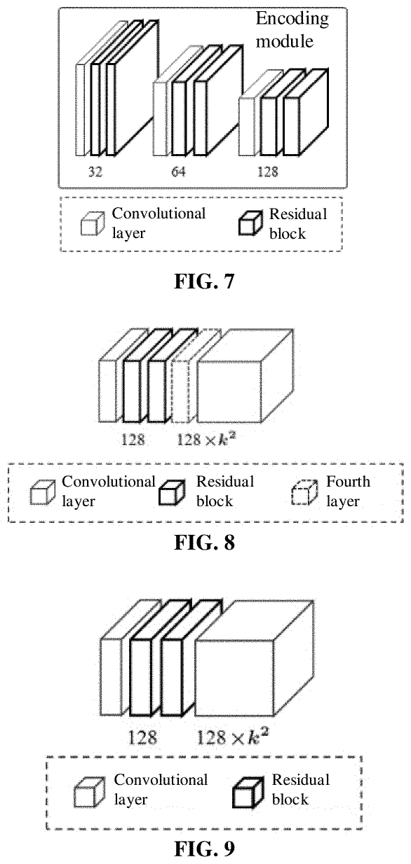

Referring to FIG. 8, FIG. 8 is a module configured to generate alignment convolution kernels according to embodiments of the application. A specific process of generating the alignment convolution kernels according to the module shown in FIG. 8 may refer to 503 to 504.

In 503, convolution processing is performed on the fourth feature image to obtain a fifth feature image.

As shown in FIG. 8, the fourth feature image is input to the module shown in FIG. 8, and the fourth feature image is sequentially processed through a convolutional layer of which a number of channels is 128 (a size of a convolution kernel is 3*3) and two residual blocks of which numbers of channels are 64 (each residual block includes two convolutional layers, and sizes of convolution kernels of the convolutional layers are 3*3) to implement convolution processing for the fourth feature image and extract the motion information between the pixels of the (N−1)th frame of image and pixels of the Nth frame of image in the fourth feature image to obtain the fifth feature image.

It is to be understood that the size of the image is not changed through the above processing for the fourth feature image, namely a size of the obtained fifth feature image is the same as the size of the fourth feature image.

Following the example 3 (as an example 4), the size of the fourth feature image is 25*25*128, and the size of the fifth feature image obtained by processing in 303 is also 25*25*128.

In 504, a number of channels of the fifth feature image is regulated to a first preset value by convolution processing to obtain the alignment convolution kernels.

For further extracting the motion information between the pixels of the (N−1)th frame of image and pixels of the Nth frame of image in the fifth feature image, convolution processing is performed on the fifth feature image through a fourth layer in FIG. 8, and a size of the obtained alignment convolution kernel is 25*25*c*k*k (it is to be understood that the number of channels of the fifth feature image is regulated by convolution processing for the fourth layer), where c is the number of channels of the fifth feature image, k is a positive integer, and in some embodiments, a value of k is 5. For convenient processing, 25*25*c*k*k is regulated to 25*25*ck², where ck² is the first preset value.

It is to be understood that both a height and width of the alignment convolution kernel are 25. The alignment convolution kernel includes 25*25 elements, each element includes c pixels, and positions of different elements in the alignment convolution kernel are different. For example, if a plane where the width and height of the alignment convolution kernel are located is defined as an xoy plane, each element in the alignment convolution kernel may be determined by a coordinate (x, y), where o is an origin. The element of the alignment convolution kernel is a convolution kernel for performing alignment processing on a pixel during subsequent processing, and a size of each element is 1*1*ck².

Following the example 4 (as an example 5), the size of the fifth feature image is 25*25*128, and the size of the alignment convolution kernel obtained by processing in 304 is also 25*25*128*k*k, i.e., 25*25*128k². The alignment convolution kernel includes 25*25 elements, each element includes 128 pixels, and positions of different elements in the alignment convolution kernel are different. The size of each element is 1*1*128*k².

The fourth layer is a convolutional layer, and if a convolution kernel of a convolutional layer is larger, a data processing load is higher. In some embodiments, the fourth layer in FIG. 8 is a convolutional layer of which a number of channels is 128 and a size of a convolution kernel is 1*1. The number of channels of the fifth feature image through the convolutional layer of which the size of the convolution kernel is 1*1, so that the data processing load may be reduced, and the processing speed may be increased.

In 505, numbers of channels of the alignment convolution kernels are regulated to a second preset value by convolution processing to obtain a sixth feature image.

The number of channels of the fifth feature image is regulated by convolution processing (i.e., the fourth layer in FIG. 8) in 504, so that it is necessary to regulate the numbers of channels of the alignment convolution kernels to the second preset value (i.e., the number of channels of the fifth feature image) before convolution processing is performed on the alignment convolution kernels to obtain the deblurring convolution kernels.

In a possible implementation mode, the numbers of channels of the alignment convolution kernels are regulated to the second preset value by convolution processing to obtain the sixth feature image. In some embodiments, convolution processing may be implemented through a convolutional layer of which a number of channels is 128 and a size of a convolution kernel is 1*1.

In 506, concatenation processing is performed on the fourth feature image and the sixth feature image in the channel dimension to obtain a seventh feature image.

In the embodiment, 502 to 504 focus more on extraction of the motion information between the pixels of the (N−1)th frame of image and the pixels of the Nth frame of image. Since subsequent processing requires extraction of the deblurring information between the pixels of the (N−1)th frame of image and pixels of the (N−1)th frame of deblurred image in the image to be processed, before subsequent processing, the fourth feature image and the sixth feature image are concatenated to add the deblurring information between the pixels of the (N−1)th frame of image and the pixels of the (N−1)th frame of deblurred image in the feature image.

In a possible implementation mode, concatenation processing is performed on the fourth feature image and the sixth feature image, namely concatenation processing is performed on the fourth feature image and the sixth feature image, to obtain the seventh feature image.

In 507, convolution processing is performed on the seventh feature image to extract deblurring information of pixels of the (N−1)th frame of deblurred image relative to the pixels of the (N−1)th frame of image to obtain the deblurring convolution kernels.

The seventh feature image includes the extracted deblurring information between the pixels of the (N−1)th frame of image and the pixels of the (N−1)th frame of deblurred image, and convolution processing may be performed on the seventh feature image to further extract the deblurring information between the pixels of the (N−1)th frame of image rand the pixels of the (N−1)th frame of deblurred image to obtain the deblurring convolution kernels. The process includes the following operations.

Convolution processing is performed on the seventh feature image to obtain an eighth feature image. A number of channels of the eighth feature image is regulated to the first preset value by convolution processing to obtain the deblurring convolution kernels.

In some possible implementation modes, as shown in FIG. 9, the seventh feature image is input to a module shown in FIG. 9, and the seventh feature image is sequentially processed through a convolutional layer of which a number of channels is 128 (a size of a convolution kernel is 3*3) and two residual blocks of which numbers of channels are 64 (each residual block includes two convolutional layers, and sizes of convolution kernels of the convolutional layers are 3*3) to implement convolution processing for the seventh feature image and extract the deblurring information between the pixels of the (N−1)th frame of image and pixels of the (N−1)th frame of deblurred image in the seventh feature image to obtain the eighth feature image.

A processing process of the module shown in FIG. 9 for the seventh feature image may refer to the processing process of the module shown in FIG. 8 on the fourth feature image and will not be elaborated herein.

It is to be understood that comparison between the module (configured to generate the alignment convolution kernel) shown in FIG. 8 and the module (configured to generate the deblurring convolution kernel) shown in FIG. 9 shows that the module shown in FIG. 8 includes one more convolutional layer (i.e., the fourth layer of the module shown in FIG. 8) than the module shown in FIG. 9, and although the other compositions are the same, weights of the two are different, which directly determines different uses thereof.

In some embodiments, the weights of the module shown in FIG. 8 and the module shown in FIG. 9 may be obtained by training the modules shown in FIG. 8 and FIG. 9.

It is to be understood that the deblurring convolution kernels obtained in 507 include deblurring convolution kernels used for all pixels in the seventh feature image, and a size of the convolution kernel for each pixel is 1*1*ck².

Following the example 5 (as an example 6), a size of the seventh feature image is 25*25*128*k*k. That is, the seventh feature image includes 25*25 pixels. Correspondingly, the obtained deblurring convolution kernels (the sizes are 25*25*128k²) includes 25*25 deblurring convolution kernels (namely each pixel corresponds to a deblurring convolution kernel, and the size of the deblurring convolution kernel for each pixel is 1*1*128k²).

Information of three dimensions of each pixel in the seventh feature image is integrated to information of one dimension, and information of all pixels in the seventh feature image are integrated to a convolution kernel, i.e., the deblurring convolution kernel for each pixel.

In the embodiment, convolution processing is performed on the feature image of the image to be processed to extract the motion information between the pixels of the (N−1)th frame of image and the pixels of the Nth frame of image to obtain the alignment convolution kernel for each pixel. Then, convolution processing is performed on the seventh feature image to extract the deblurring information between the pixels of the (N−1)th frame of image and the pixels of the (N−1)th frame of deblurred image to obtain the deblurring convolution kernel for each pixel to facilitate subsequent deblurring processing of the Nth frame of image through the alignment convolution kernel and the deblurring convolution kernel.

How to obtain the deblurring convolution kernels and the alignment convolution kernels is elaborated in the embodiment. How to deblur the Nth frame of image through the deblurring convolution kernels and the alignment convolution kernels and obtain the Nth frame of deblurred image will be elaborated in the following embodiment.

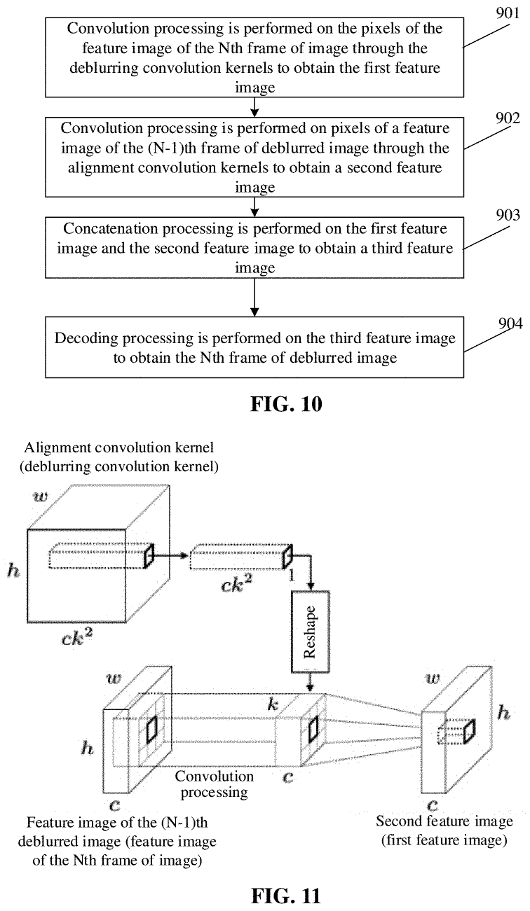

Referring to FIG. 10, FIG. 10 is a flowchart of another video image processing method according to embodiments of the application. As shown in FIG. 10, the method includes the following operations.

In 901, convolution processing is performed on the pixels of the feature image of the Nth frame of image through the deblurring convolution kernels to obtain the first feature image.

The feature image of the Nth frame of image may be obtained by performing feature extraction processing on the Nth frame of image. Feature extraction processing may be convolution processing and may also be pooling processing, and no limits are made thereto in the embodiment of the application.

In a possible implementation mode, feature extraction processing may be performed on the Nth frame of image through the encoding module shown in FIG. 7 to obtain the feature image of the Nth frame of image. The specific composition in FIG. 7 and the processing process of FIG. 7 for the Nth frame of image may refer to 502 and will not be elaborated herein.

The size of the feature image, obtained by performing feature extraction processing on the Nth frame of image through the encoding module shown in FIG. 7, of the Nth frame of image is smaller than the size of the Nth frame of image, and the feature image of the Nth frame of image includes information of the Nth frame of image (in the application, the information may be understood as information of a blurred region in the Nth frame of image), so that when the feature image of the Nth frame of image is subsequently processed, the data processing load may be reduced, and the processing speed may be increased.

As mentioned above, convolution processing is performed on each pixel in the image to be processed to obtain the deblurring convolution kernel for each pixel. Performing convolution processing on the pixels of the feature image of the Nth frame of image through the deblurring convolution kernel refers to performing convolution processing on each pixel of the feature image of the Nth frame of image by taking the deblurring convolution kernel for each pixel in the deblurring convolution kernels obtained in the abovementioned embodiment as a convolution kernel for the corresponding pixel in the feature image of the Nth frame of image.

As mentioned in 507, the deblurring convolution kernel for each pixel in the deblurring convolution kernels includes the information of each pixel in the seventh feature image, and the information is one-dimensional information in the deblurring convolution kernel. The pixels of the feature image of the Nth frame of image is three-dimensional, so that it is necessary to reshape the deblurring convolution kernels to perform convolution processing by taking the information of each pixel in the seventh feature image as the convolution kernel for each pixel in the feature image of the Nth frame of image. Based on such a consideration, an implementation process of 901 includes the following operations.

The deblurring convolution kernel is reshaped to make a number of channels of the deblurring convolution kernel the same as a number of channels of the feature image of the Nth frame of image. Convolution processing is performed on the pixels of the feature image of the Nth frame of image through the reshaped deblurring convolution kernels to obtain the first feature image.

Referring to FIG. 11, through a module (adaptive convolution processing module) shown in FIG. 11, the deblurring convolution kernel for each pixel in the deblurring convolution kernels obtained in the abovementioned embodiment may be taken as the convolution kernel for the corresponding pixel in the feature image of the Nth frame of image, and convolution processing may be performed on the pixel.

Reshape in FIG. 11 refers to regulating the dimensions of the deblurring convolution kernel for each pixel in the deblurring convolution kernels, namely regulating the dimensions of the deblurring kernel for each pixel from 1*1*ck² to c*k*k.

Following the example 6 (as an example 7), the size of the deblurring convolution kernel for each pixel is 1*1*128k², and a size of a convolution kernel obtained after the deblurring convolution kernel for each pixel is reshaped is 128*k*k.

The deblurring convolution kernel for each pixel of the feature image of the Nth frame of image is obtained by reshaping, and convolution processing is performed on each pixel through the deblurring convolution kernel for each pixel to deblur each pixel of the feature image of the Nth frame of image to finally obtain the first feature image.

In 902, convolution processing is performed on pixels of a feature image of the (N−1)th frame of deblurred image through the alignment convolution kernels to obtain a second feature image.

In some embodiments, the operation that convolution processing is performed on the pixels of the feature image of the (N−1)th frame of deblurred image through the alignment convolution kernels to obtain the second feature image includes that: the alignment convolution kernels are reshaped to make numbers of channels of the alignment convolution kernels the same as a number of channels of the feature image of the (N−1)th frame of image; and convolution processing is performed on the pixels of the feature image of the (N−1)th frame of deblurred image through the reshaped alignment convolution kernels to obtain the second feature image.

In the embodiment, like implementation of deblurring processing for the feature image of the Nth frame of image through the module shown in FIG. 11 by taking the deblurring convolution kernels obtained in the abovementioned embodiment as the deblurring convolution kernel for each pixel of the feature image of the Nth frame of image in 901, through the module shown in FIG. 11, the alignment convolution kernel for each pixel in the alignment convolution kernel obtained in the abovementioned embodiment is reshaped to 128*k*k and convolution processing is performed on the corresponding pixel in the feature image of the (N−1)th frame of deblurred image through the reshaped alignment convolution kernels. Alignment processing for the feature image of the (N−1)th frame of deblurred image is implemented based on a present frame, namely a position of each pixel in the feature image of the (N−1)th frame of deblurred image is regulated according to the motion information in the alignment kernels for each pixel to obtain the second feature image.

The feature image of the (N−1)th frame of deblurred image includes a large number of clear (namely there is no blur) pixels, but there is a shift between pixels in the feature image of the (N−1)th frame of deblurred image and pixels of the present frame. Therefore, the positions of the pixels of the feature image of the (N−1)th frame of deblurred image is regulated by processing in 902 to make the pixels of which the positions are regulated closer to the position at the moment of the Nth frame of image (herein, the position refers to a position of the shot object in the Nth frame of image). In such a manner, the Nth frame of image may be deblurred by use of information of the second feature image during subsequent processing.

It is to be understood that there is no sequence between 901 and 902, namely 901 may be executed at first and then 902 is executed, or 902 may be executed at first and then 901 is executed, or 901 and 902 may be executed at the same time. Furthermore, after the alignment convolution kernels are obtained through 504, 901 may be executed at first and then 505 to 507 are executed, or 505 to 507 may be executed at first and then 901 or 902 is executed. No limits are made thereto in some embodiments.

In 903, concatenation processing is performed on the first feature image and the second feature image to obtain a third feature image.

Concatenation processing may be performed on the first feature image and the second feature image to improve the deblurring effect by use of the information of the feature image of the (aligned) (N−1)th frame of image based on the motion information between the pixels of the (N−1)th frame of image and the pixels of the Nth frame of image and the deblurring information between the pixels of the (N−1)th frame of image and the pixels of the (N−1)th frame of deblurred image.

In a possible implementation mode, concatenation processing is performed on the first feature image and the second feature image in the channel dimension to obtain the third feature image.

In 904, decoding processing is performed on the third feature image to obtain the Nth frame of deblurred image.

In some embodiments, decoding processing may be any one of deconvolution processing, transposed convolution processing, bilinear interpolation processing and inverse unpooling processing, and may also be a combination of convolution processing and any one of deconvolution processing, transposed convolution processing, bilinear interpolation processing and unpooling processing. No limits are made thereto in the application.

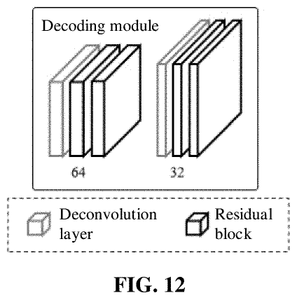

In a possible implementation mode, referring to FIG. 12, FIG. 12 shows a decoding module, which sequentially includes a deconvolution layer of which a number of channels is 64 (a size of a convolution kernel is 3*3), two residual blocks of which numbers of channels are 64 (each residual block includes two convolutional layers, and sizes of convolution kernels of the convolutional layers are 3*3), a deconvolution layer of which a number of channels is 32 (a size of a convolution kernel is 3*3) and two residual blocks of which numbers of channels are 32 (each residual block includes two convolutional layers, and sizes of convolution kernels of the convolutional layers are 3*3). The operation that decoding processing is performed on the third feature image through the decoding module shown in FIG. 12 to obtain the Nth frame of deblurred image includes the following operations: deconvolution processing is performed on the third feature image to obtain a ninth feature image; and convolution processing is performed on the ninth feature image to obtain an Nth frame of decoded image.

In some embodiments, after the Nth frame of decoded image is obtained, a pixel value of a first pixel of the Nth frame of image and a pixel value of a second pixel of the Nth frame of decoded image may further be added to obtain the Nth frame of deblurred image, a position of the first pixel in the Nth frame of image being the same as a position of the second pixel in the Nth frame of decoded image. Therefore, the Nth frame of deblurred image is more natural.

Through the embodiment, deblurring processing may be performed on the feature image of the Nth frame of image through the deblurring convolution kernels obtained in the abovementioned embodiment, and alignment processing may be performed on the feature image of the (N−1)th frame of image through the alignment convolution kernels obtained in the abovementioned embodiment. Decoding processing is performed on the third feature image obtained by concatenating the first feature image obtained by deblurring processing and the second feature image obtained by alignment processing, so that the deblurring effect on the Nth frame of image may be improved, and the Nth frame of deblurred image is more natural. In addition, action objects of both deblurring processing and alignment processing in the embodiment are feature images, so that the data processing load is low, the processing speed is high, and real-time deblurring of the video images may be implemented.

The application also provides a video image deblurring neural network, configured to implement the method in the abovementioned embodiments.

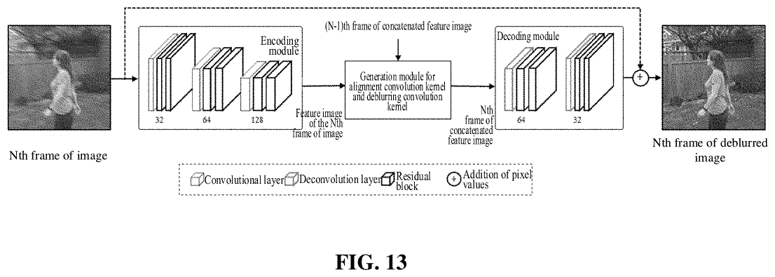

Referring to FIG. 13, FIG. 13 is a structure diagram of a video image deblurring neural network according to embodiments of the application. As shown in FIG. 13, the video image deblurring neural network includes an encoding module, a generation module for alignment convolution kernel and deblurring convolution kernel and a decoding module. The encoding module in FIG. 13 is the same as the encoding module shown in FIG. 7, and the decoding module in FIG. 13 is the same as the decoding module shown in FIG. 12. Elaborations are omitted herein.

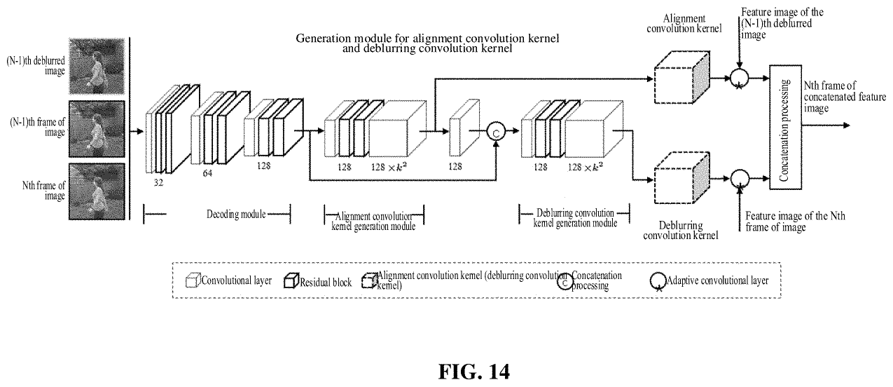

Referring to FIG. 14, the generation module for alignment convolution kernel and deblurring convolution kernel shown in FIG. 14 includes a decoding module, an alignment convolution kernel generation module and a deblurring convolution kernel generation module, there is a convolutional layer of which a number of channels is 128 and a size of a convolution kernel is 1*1 between the alignment convolution kernel generation module and the deblurring convolution kernel generation module, and a concatenation layer is connected after the convolutional layer.

It is to be noted that the adaptive convolutional layer shown in FIG. 14 is the module shown in FIG. 11. The alignment convolution kernels and deblurring convolution kernels generated by the module shown in FIG. 14 perform convolution processing (i.e., alignment processing and deblurring processing) on the pixels of the feature image of the (N−1)th frame of image and the pixels of the feature image of the Nth frame of image through the adaptive convolutional layer to obtain an aligned feature image of the feature image of the (N−1)th frame of image and a deblurred feature image of the feature image of the Nth frame of image.

The aligned feature image and the deblurred feature image are concatenated in the channel dimension to obtain an Nth frame of concatenated feature image, and the Nth frame of concatenated feature image is input to the decoding module and used as an input for processing an (N+1)th frame of image by the video image deblurring neural network.

The Nth frame of decoded image is obtained by performing decoding processing on the Nth frame of concatenated feature image, a pixel value of a first pixel of the Nth frame of image and a pixel value of a second pixel of the Nth frame of decoded image may further be added to obtain the Nth frame of deblurred image, a position of the first pixel in the Nth frame of image being the same as a position of the second pixel in the Nth frame of decoded image. The Nth frame of image and the Nth frame of deblurred image are taken as an input for processing the (N+1)th frame of image by the video image deblurring neural network.

It is easy to see from the process that deblurring processing of the video image deblurring neural network for each frame of image in a video requires four inputs. For example, if a deblurring object is the Nth frame of image, the four inputs are the (N−1)th frame of image, the (N−1)th frame of deblurred image, the Nth frame of image and the feature image (i.e., the Nth frame of concatenated feature image) of the (N−1)th frame of deblurred image.

Deblurring processing may be performed on the video images through the video image deblurring neural network provided in the embodiments, only four inputs are required in the whole processing process to directly obtain the deblurred image, and the processing speed is high. The deblurring convolution kernel and the alignment convolution kernel are generated for each pixel in the image through the deblurring convolution kernel generation module and the alignment convolution kernel generation module, so that the deblurring effect of the video image deblurring neural network on different frames of non-uniformly blurred images in the video may be improved.

Based on the video image deblurring neural network provided in the embodiments, the embodiments of the application provide a training method for the video image deblurring neural network.

In the embodiment, an error between the Nth frame of deblurred image output by the video image deblurring neural network and a clear image of the Nth frame of image (i.e., a ground truth of the Nth frame of image) is determined according to a mean square error loss function. A specific expression of the mean square error loss function is as follows:

$${ℒ}_{mse} = \frac{1}{CHW} {‖ R - S ‖}^{2} . \qquad ( 1 )$$

C, H and W are the numbers of channels, height and width of the Nth frame of image respectively (there is made such a hypothesis that deblurring processing is performed on the Nth frame of image through the video image deblurring neural network), R is the Nth frame of deblurred image input by the video image deblurring neural network, and S is the ground truth of the Nth frame of image.

A Euclidean distance between a feature of the Nth frame of deblurred image output by the VGG-19 network and a feature of the ground truth of the Nth frame of image is determined through a perceptual loss function. A specific expression of the perceptual loss function is as follows:

$${ℒ}_{p} = \frac{1}{{j}_{} {j}_{} {j}_{}} {‖ {Φ}_{j} ( R ) - {Φ}_{j} ( S ) ‖}^{2} . \qquad ( 2 )$$

Φ(⋅) is a feature image output by a jth layer in the pretrained VGG-19 network, [symbol] ⱼ, [symbol] ⱼ and [symbol] ⱼ are the numbers of channels, height and width of the feature image respectively, R is the Nth frame of deblurred image input by the video image deblurring neural network, and S is the ground truth of the Nth frame of image.

Finally, in the embodiment, weighted summation is performed on the formula (1) and the formula (2) to obtain a loss function of the video image deblurring neural network. A specific expression is as follows:

[symbol]

_{d}= [symbol] ₘₛₑ+λ [symbol] _{P} (3).

λ is a weight. In some embodiments, λ is a natural number.

In some embodiments, a value of j may be 15, and a value of λ is 0.01.

Based on the loss function provided in the embodiment, training for the video image deblurring neural network of the embodiment may be completed.

According to the video image processing method and video image deblurring neural network provided in the abovementioned embodiments, the embodiments of the application provide some possible implementation scenario scenarios.

The embodiments of the application may be applied to an unmanned aerial vehicle to deblur a video image shot by the unmanned aerial vehicle in real time to provide a clearer video for a user. Meanwhile, a flight control system of the unmanned aerial vehicle performs processing based on the deblurred video image to control a pose and motion of the unmanned aerial vehicle, so that the control accuracy may be improved, and strong supports may be provided for various aerial operations of the unmanned aerial vehicle.

The embodiments of the application may also be applied to a mobile terminal (for example, a mobile phone and a motion camera). A user performs video collection on an object that motions strenuously through the terminal, and the terminal may process a video shot by the user in real time by running the method provided in the embodiments of the application to reduce blurs generated by strenuous motions of the shot object and improve user experiences. The strenuous motion of the shot object refers to a relative motion between the terminal and the shot object.

The video image processing method provided in the embodiments of the application has high processing speed and good real-time performance. The neural network provided in the embodiments of the application involves few weights, and few processing resources are required by running the neural network, so that applicability to a mobile terminal is ensured.

The method of the embodiments of the application is elaborated above, and a device of the embodiments of the application will be provided below.

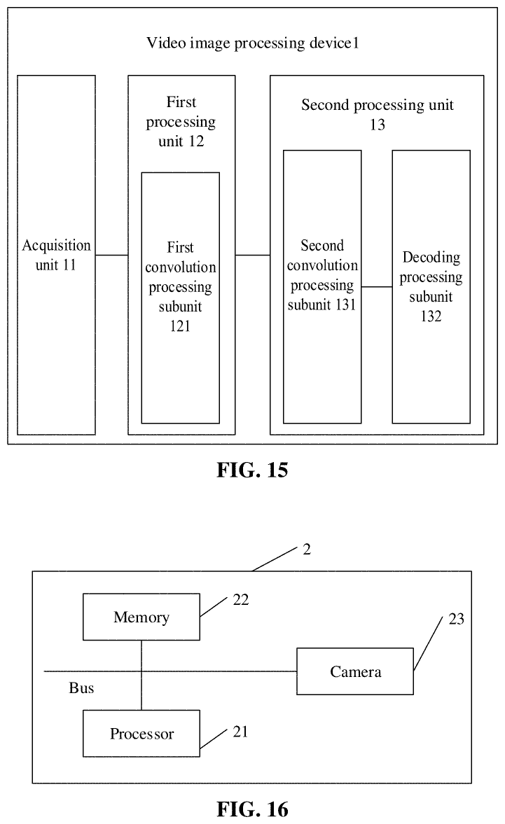

Referring to FIG. 15, FIG. 15 is a structure diagram of a video image processing device according to embodiments of the application. The device 1 includes an acquisition unit 11, a first processing unit 12 and a second processing unit 13.

The acquisition unit 11 is configured to acquire multiple frames of continuous video images, the multiple frames of continuous video images including an Nth frame of image, an (N−1)th frame of image and an (N−1)th frame of deblurred image and N being a positive integer.

The first processing unit 12 is configured to obtain deblurring convolution kernels for the Nth frame of image based on the Nth frame of image, the (N−1)th frame of image and the (N−1)th frame of deblurred image.

The second processing unit 13 is configured to perform deblurring processing on the Nth frame of image through the deblurring convolution kernels to obtain an Nth frame of deblurred image.

In a possible implementation mode, the first processing unit 12 includes a first convolution processing subunit 121, configured to perform convolution processing on pixels of an image to be processed to obtain the deblurring convolution kernels, the image to be processed being obtained by concatenating the Nth frame of image, the (N−1)th frame of image and the (N−1)th frame of deblurred image in a channel dimension.

In another possible implementation mode, the first convolution processing subunit 121 is configured to perform convolution processing on the image to be processed to extract motion information of pixels of the (N−1)th frame of image relative to pixels of the Nth frame of image to obtain alignment convolution kernels, the motion information including a velocity and a direction, and perform encoding processing on the alignment convolution kernels to obtain the deblurring convolution kernels.

In another possible implementation mode, the second processing unit 13 includes: a second convolution processing subunit 131, configured to perform convolution processing on pixels of a feature image of the Nth frame of image through the deblurring convolution kernels to obtain a first feature image; and a decoding processing subunit 132, configured to perform decoding processing on the first feature image to obtain the Nth frame of deblurred image.

In another possible implementation mode, the second convolution processing subunit 131 is configured to reshape the deblurring convolution kernels to make numbers of channels of the deblurring convolution kernels the same as a number of channels of the feature image of the Nth frame of image and perform convolution processing on the pixels of the feature image of the Nth frame of image through the reshaped deblurring convolution kernels to obtain the first feature image.

In another possible implementation mode, the first convolution processing subunit 121 is further configured to, after convolution processing is performed on the image to be processed to extract the motion information of the pixels of the (N−1)th frame of image relative to the pixels of the Nth frame of image to obtain the alignment convolution kernels, perform convolution processing on pixels of a feature image of the (N−1)th frame of deblurred image through the alignment convolution kernels to obtain a second feature image.

In another possible implementation mode, the first convolution processing subunit 121 is further configured to reshape the alignment convolution kernels to make numbers of channels of the alignment convolution kernels the same as a number of channels of the feature image of the (N−1)th frame of image and perform convolution processing on the pixels of the feature image of the (N−1)th frame of deblurred image through the reshaped alignment convolution kernels to obtain the second feature image.

In another possible implementation mode, the second processing unit 13 is configured to perform concatenation processing on the first feature image and the second feature image to obtain a third feature image and perform decoding processing on the third feature image to obtain the Nth frame of deblurred image.

In another possible implementation mode, the first convolution processing subunit 121 is further configured to perform concatenation processing on the Nth frame of image, the (N−1)th frame of image and the (N−1)th frame of deblurred image in the channel dimension to obtain the image to be processed, perform encoding processing on the image to be processed to obtain a fourth feature image, perform convolution processing on the fourth feature image to obtain a fifth feature image and regulate a number of channels of the fifth feature image to a first preset value by convolution processing to obtain the alignment convolution kernel.

In another possible implementation mode, the first convolution processing subunit 121 is further configured to regulate the numbers of channels of the alignment convolution kernels to a second preset value by convolution processing to obtain a sixth feature image, perform concatenation processing on the fourth feature image and the sixth feature image to obtain a seventh feature image and perform convolution processing on the seventh feature image to extract the deblurring information of the pixels of the (N−1)th frame of deblurred image relative to the pixels of the (N−1)th frame of image to obtain the deblurring convolution kernels.

In another possible implementation mode, the first convolution processing subunit 121 is further configured to perform convolution processing on the seventh feature image to obtain an eighth feature image and regulate a number of channels of the eighth feature image to the first preset value by convolution processing to obtain the deblurring convolution kernels.

In another possible implementation mode, the second processing unit 13 is further configured to perform deconvolution processing on the third feature image to obtain a ninth feature image, perform convolution processing on the ninth feature image to obtain an Nth frame of decoded image and add a pixel value of a first pixel of the Nth frame of image and a pixel value of a second pixel of the Nth frame of decoded image to obtain the Nth frame of deblurred image, a position of the first pixel in the Nth frame of image being the same as a position of the second pixel in the Nth frame of decoded image.

In some embodiments, functions or units of the device provided in the embodiments of the disclosure may be configured to execute the method described in the method embodiments and specific implementation thereof may refer to the descriptions about the method embodiment and, for simplicity, will not be elaborated herein.

The embodiments of the application also provide an electronic device, which includes a processor, an input device, an output device and a memory. The processor, the input device, the output device and the memory are connected with one another. The memory stores program instructions. The program instructions are executed by the processor to enable the processor to execute the method of the embodiments of the application

The embodiments of the application also provide a processor, which is configured to execute the method of the embodiments of the application.

FIG. 16 is a hardware structure diagram of an electronic device according to embodiments of the application. The electronic device 2 includes a processor 21, a memory 22 and a camera 23. The processor 21, the memory 24 and the camera 23 are coupled through a connector. The connector includes various interfaces, transmission lines or buses, etc. No limits are made thereto in the embodiments of the application. It is to be understood that, in each embodiment of the application, coupling refers to interconnection implemented in a specific manner, including direct connection or direct connection through another device, for example, connection through various interfaces, transmission lines and buses.

The processor 21 may be one or more Graphics Processing Units (GPUs). Under the condition that the processor 21 is one GPU, the GPU may be a single-core GPU and may also be a multi-core GPU. In some embodiments, the processor 21 may be a processor set consisting of multiple GPUs, and multiple processors are coupled with one another through one or more buses. In some embodiments, the processor may also be a process of another type and the like. No limits are made in the embodiments of the application.

The memory 22 may be configured to store a computer program instruction and various computer program codes including a program code configured to execute the solutions of the application. In some embodiments, the memory includes, but not limited to, a Random Access Memory (RAM), a Read-Only Memory (ROM), an Erasable Programmable ROM (EPROM) or a Compact Disc Read-Only Memory (CD-ROM). The memory is configured for related instructions and data.

The camera 23 may be configured to acquire a related video or image, etc.

It can be understood that, in the embodiments of the application, the memory may not only be configured to store related instructions but also be configured to store related images and videos. For example, the memory may be configured to store a video acquired through the camera 23, or the memory may also be configured to store a deblurred image generated through the processor 21 and the like. Videos or images specifically stored in the memory are not limited in the embodiment of the application.

It can be understood that FIG. 16 only shows a simplified design of the video image processing device. During a practical application, the video image processing device may further include other required components, including, but not limited to, any number of input/output devices, processors, controllers, memories and the like. All devices capable of implementing the embodiments of the application fall within the scope of protection of the application.

The embodiments of the application also provide a computer-readable storage medium, in which a computer program is stored, the computer program including program instructions and the program instructions being executed by a processor of an electronic device to enable the processor to execute the method of the embodiments of the application.

Through the technical solution provided in the embodiments of the application, the deblurring convolution kernels for the Nth frame of image in the video images may be obtained, and then convolution processing is performed on the Nth frame of image through the deblurring convolution kernels for the Nth frame of image, so that the Nth frame of image may be effectively deblurred to obtain the Nth frame of deblurred image.

Those of ordinary skill in the art may realize that the units and algorithm steps of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the application.

Those skilled in the art may clearly learn about that specific working processes of the system, device and unit described above may refer to the corresponding processes in the method embodiment and will not be elaborated herein for convenient and brief description. Those skilled in the art may also clearly know that the embodiments of the application are described with different focuses. For convenient and brief description, elaborations about the same or similar parts may be omitted in different embodiments, and thus parts that are not described or detailed in an embodiment may refer to records in the other embodiments.

In some embodiments provided by the application, it is to be understood that the disclosed system, device and method may be implemented in another manner. For example, the device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the application may be integrated into a processing unit, each unit may also physically exist independently, and two or more than two units may also be integrated into a unit.

The embodiments may be implemented completely or partially through software, hardware, firmware or any combination thereof. During implementation with the software, the embodiments may be implemented completely or partially in form of computer program product. The computer program product includes one or more computer instructions. When the computer program instruction is loaded and executed on a computer, the flows or functions according to the embodiments of the application are completely or partially generated. The computer may be a universal computer, a dedicated computer, a computer network or another programmable device. The computer instruction may be stored in a computer-readable storage medium or transmitted through the computer-readable storage medium. The computer instruction may be transmitted from one website, computer, server or data center to another website, computer, server or data center in a wired (for example, a coaxial cable, an optical fiber and a Digital Subscriber Line (DSL)) or wireless (for example, infrared, radio and microwave) manner. The computer-readable storage medium may be any available medium accessible for the computer or a data storage device, such as a server and a data center, including one or more integrated available media. The available medium may be a magnetic medium (for example, a floppy disk, a hard disk and a magnetic tape), an optical medium (for example, a Digital Versatile Disc (DVD)), a semiconductor medium (for example, a Solid State Disk (SSD)) or the like.

It can be understood by those of ordinary skill in the art that all or part of the flows in the method of the abovementioned embodiments may be completed by instructing related hardware through a computer program, the program may be stored in a computer-readable storage medium, and when the program is executed, the flows of each method embodiment may be included. The storage medium includes: various media capable of storing program codes such as a ROM, a RAM, a magnetic disk or an optical disk.

1. A video image processing method, comprising:
acquiring multiple frames of continuous video images, the multiple frames of continuous video images comprising an Nth frame of image, an (N−1)th frame of image and an (N−1)th frame of deblurred image and N being a positive integer;
obtaining deblurring convolution kernels for the Nth frame of image based on the Nth frame of image, the (N−1)th frame of image and the (N−1)th frame of deblurred image; and
performing deblurring processing on the Nth frame of image through the deblurring convolution kernels to obtain an Nth frame of deblurred image.

2. The method of claim 1, wherein obtaining the deblurring convolution kernels for the Nth frame of image based on the Nth frame of image, the (N−1)th frame of image and the (N−1)th frame of deblurred image comprises:
performing convolution processing on pixels of an image to be processed to obtain the deblurring convolution kernels, the image to be processed being obtained by concatenating the Nth frame of image, the (N−1)th frame of image and the (N−1)th frame of deblurred image in a channel dimension.

3. The method of claim 2, wherein performing convolution processing on the pixels of the image to be processed to obtain the deblurring convolution kernels comprises:
performing convolution processing on the image to be processed to extract motion information of pixels of the (N−1)th frame of image relative to pixels of the Nth frame of image to obtain alignment convolution kernels, the motion information comprising a velocity and a direction; and
performing encoding processing on the alignment convolution kernels to obtain the deblurring convolution kernels.

4. The method of claim 2, wherein performing deblurring processing on the Nth frame of image through the deblurring convolution kernels to obtain the Nth frame of deblurred image comprises:
performing convolution processing on pixels of a feature image of the Nth frame of image through the deblurring convolution kernels to obtain a first feature image; and
performing decoding processing on the first feature image to obtain the Nth frame of deblurred image.

5. The method of claim 4, wherein performing convolution processing on the pixels of the feature image of the Nth frame of image through the deblurring convolution kernels to obtain the first feature image comprises:
reshaping the deblurring convolution kernels to make numbers of channels of the deblurring convolution kernels the same as a number of channels of the feature image of the Nth frame of image; and
performing convolution processing on the pixels of the feature image of the Nth frame of image through the reshaped deblurring convolution kernels to obtain the first feature image.

6. The method of claim 3, after performing convolution processing on the image to be processed to extract the motion information of the pixels of the (N−1)th frame of image relative to the pixels of the Nth frame of image to obtain the alignment convolution kernels, further comprising:
performing convolution processing on pixels of a feature image of the (N−1)th frame of deblurred image through the alignment convolution kernels to obtain a second feature image.

7. The method of claim 6, wherein performing convolution processing on the pixels of the feature image of the (N−1)th frame of deblurred image through the alignment convolution kernels to obtain the second feature image comprises:
reshaping the alignment convolution kernels to make numbers of channels of the alignment convolution kernels the same as a number of channels of the feature image of the (N−1)th frame of image; and
performing convolution processing on the pixels of the feature image of the (N−1)th frame of deblurred image through the reshaped alignment convolution kernels to obtain the second feature image.

8. The method of claim 4, wherein performing decoding processing on the first feature image to obtain the Nth frame of deblurred image comprises:
performing concatenation processing on the first feature image and a second feature image to obtain a third feature image; and
performing decoding processing on the third feature image to obtain the Nth frame of deblurred image.

9. The method of claim 3, wherein performing convolution processing on the image to be processed to extract the motion information of the pixels of the (N−1)th frame of image relative to the pixels of the Nth frame of image to obtain the alignment convolution kernels comprises:
performing concatenation processing on the Nth frame of image, the (N−1)th frame of image and the (N−1)th frame of deblurred image in the channel dimension to obtain the image to be processed;
performing encoding processing on the image to be processed to obtain a fourth feature image;
performing convolution processing on the fourth feature image to obtain a fifth feature image; and
regulating a number of channels of the fifth feature image to a first preset value by convolution processing to obtain the alignment convolution kernels.

10. The method of claim 9, wherein performing encoding processing on the alignment convolution kernels to obtain the deblurring convolution kernels comprises:
regulating the numbers of channels of the alignment convolution kernels to a second preset value by convolution processing to obtain a sixth feature image;
performing concatenation processing on the fourth feature image and the sixth feature image to obtain a seventh feature image; and
performing convolution processing on the seventh feature image to extract deblurring information of pixels of the (N−1)th frame of deblurred image relative to pixels of the (N−1)th frame of image to obtain the deblurring convolution kernels.

11. The method of claim 10, wherein performing convolution processing on the seventh feature image to extract the deblurring information of the pixels of the (N−1)th frame of deblurred image relative to the pixel of the (N−1)th frame of image to obtain the deblurring convolution kernels comprises:
performing convolution processing on the seventh feature image to obtain an eighth feature image; and
regulating a number of channels of the eighth feature image to the first preset value by convolution processing to obtain the deblurring convolution kernels.

12. The method of claim 8, wherein performing decoding processing on the third feature image to obtain the Nth frame of deblurred image comprises:
performing deconvolution processing on the third feature image to obtain a ninth feature image;
performing convolution processing on the ninth feature image to obtain an Nth frame of decoded image; and
adding a pixel value of a first pixel of the Nth frame of image and a pixel value of a second pixel of the Nth frame of decoded image to obtain the Nth frame of deblurred image, a position of the first pixel in the Nth frame of image being the same as a position of the second pixel in the Nth frame of decoded image.

13. An electronic device, comprising a processor, an input device, an output device and a memory, wherein the processor, the input device, the output device and the memory are connected with one another; the memory stores program instructions; and when the program instructions are executed by the processor, the processor is configured to:
acquire multiple frames of continuous video images, the multiple frames of continuous video images comprising an Nth frame of image, an (N−1)th frame of image and an (N−1)th frame of deblurred image and N being a positive integer;
obtain deblurring convolution kernels for the Nth frame of image based on the Nth frame of image, the (N−1)th frame of image and the (N−1)th frame of deblurred image; and
perform deblurring processing on the Nth frame of image through the deblurring convolution kernels to obtain an Nth frame of deblurred image.

14. The electronic device of claim 13, wherein the processor is further configured to:
perform convolution processing on pixels of an image to be processed to obtain the deblurring convolution kernels, the image to be processed being obtained by concatenating the Nth frame of image, the (N−1)th frame of image and the (N−1)th frame of deblurred image in a channel dimension.

15. The electronic device of claim 14, wherein the processor is further configured to perform convolution processing on the image to be processed to extract motion information of pixels of the (N−1)th frame of image relative to pixels of the Nth frame of image to obtain alignment convolution kernels, the motion information comprising a velocity and a direction, and perform encoding processing on the alignment convolution kernels to obtain the deblurring convolution kernels.

16. The electronic device of claim 14, wherein the processor is further configured to: perform convolution processing on pixels of a feature image of the Nth frame of image through the deblurring convolution kernels to obtain a first feature image; and
perform decoding processing on the first feature image to obtain the Nth frame of deblurred image.

17. The electronic device of claim 16, wherein the processor is further configured to reshape the deblurring convolution kernels to make numbers of channels of the deblurring convolution kernels the same as a number of channels of the feature image of the Nth frame of image and perform convolution processing on the pixels of the feature image of the Nth frame of image through the reshaped deblurring convolution kernels to obtain the first feature image.

18. The electronic device of claim 15, wherein the processor is further configured to: after convolution processing is performed on the image to be processed to extract the motion information of the pixels of the (N−1)th frame of image relative to the pixels of the Nth frame of image to obtain the alignment convolution kernels, perform convolution processing on pixels of a feature image of the (N−1)th frame of deblurred image through the alignment convolution kernels to obtain a second feature image.

19. The electronic device of claim 18, wherein the processor is further configured to reshape the alignment convolution kernels to make numbers of channels of the alignment convolution kernels the same as a number of channels of the feature image of the (N−1)th frame of image and perform convolution processing on the pixels of the feature image of the (N−1)th frame of deblurred image through the reshaped alignment convolution kernels to obtain the second feature image.

20. A non-transitory computer-readable storage medium, in which a computer program is stored, the computer program comprising program instructions and the program instructions being executed by a processor of an electronic device to enable the processor to perform:
acquiring multiple frames of continuous video images, the multiple frames of continuous video images comprising an Nth frame of image, an (N−1)th frame of image and an (N−1)th frame of deblurred image and N being a positive integer;
obtaining deblurring convolution kernels for the Nth frame of image based on the Nth frame of image, the (N−1)th frame of image and the (N−1)th frame of deblurred image; and
performing deblurring processing on the Nth frame of image through the deblurring convolution kernels to obtain an Nth frame of deblurred image.
